(19) United States
(12) Patent Application Publication
(10) Pub. No.: US 2005/0002001 A1
(43) Pub. Date: Jan. 6, 2005

(54) Overhead projector

(76) Inventor: Joon Young Yoon, Chuncheon-city (KR)

Correspondence Address: Robert E. Krebs;Thelen Reid & Priest LLP, P.O. Box 640640, San Jose, CA, 95164, US

(21) Appl. No.: 10/756,607

(22) Filed: Jan. 12, 2004

(30) Foreign Application Priority Data
Jul. 2, 2003 (KR) 2003-44530

(51) Int. Cl. G03B 21/14

(52) U.S. Cl. 353/119

(57) ABSTRACT

An overhead projector is provided, including a main body portion 10 including a light source, a head portion 20 which projects an image of a material put on the main body portion 10 onto a screen S, and a support portion 30 which supports the head portion 20 so that the head portion 20 ascends or descends over the main body portion 10. The head portion 20 includes a head main body 21, which is supported by the support portion 30, a rotating holder 22, which is installed such as to rotate about the head main body 21, a first dove prism P1, which is installed in the head main body 21, a second dove prism P2, which is installed un the rotating holder 22 such as to have the same optical axis as the optical axis of the first dove prism P1, a lens 23, which is installed on the bottom of the rotating holder 22 and guides light projected by the main body portion 10 to the second dove prism P2, and a reflection mirror 24, which is installed on the head main body 21 and reflects light transmitted by the first dove prism P1 toward the screen S.

### BACKGROUND OF THE INVENTION

This application claims the priority of Korean Patent Application No. 2003-44530, filed on Jul. 2, 2003, in the Korean Intellectual Property Office, the disclosure of which is incorporated herein in its entirety by reference.

1. Field of the Invention

The present invention relates to an overhead projection (OHP), and more particularly, to an overhead projector which can change the phase of an image printed on a material so that a presenter can give a presentation at the most comfortable position.

2. Description of the Related Art

FIG. 1 is a view for comparing the direction of an image on a material F with the direction of an image projected onto a screen by a conventional overhead projector (OHP). As shown in FIG. 1, the OHP is comprised of a main body portion 1, which includes a light source, and a head portion 2, which projects a transparent film on the main body portion 1 onto a screen S. The material F, which is a transparent film, is put on a manuscript stand of the main body portion 1, and light emitted from the light source of the main body portion 1 passes through the material F. The light transmitted through the material F is then projected onto the screen S via a lens 2a and a reflection mirror 2b.

In the OHP having such a structure, the material F must be always put toward the audience so that the audience can properly view an image appearing on the screen S. For example, the arrow (↑) on the material F must be headed toward the audience so that the arrow (↑) printed on the material F is projected onto the screen S and appears as an upward arrow (↑) on the screen S. Hence, a presenter must stand at a location \mathring{A} to look at the material F straight. However, in this case, the presenter blocks an image projected by the head portion 2. Accordingly, the presenter must stand at location \mathring{B} or \mathring{C} instead of the location \mathring{A}. In other words, since the presenter stands beside the material F, the contents of the material F are not the right way up and the presenter has difficulty writing something on the material F.

### SUMMARY OF THE INVENTION

The present invention provides an overhead projector which can change the phase of an image printed on a material so that a presenter can present the material at the most comfortable position.

According to an aspect of the present invention, there is provided an overhead projector comprising a main body portion 10, a head portion 20, and a support portion 30. The main body portion includes a light source. The head portion 20 projects an image of a material put on the main body portion 10 onto a screen S. The support portion 30 supports the head portion 20 so that the head portion 20 ascends or descends over the main body portion 10. The head portion 20 comprises a head main body 21, which is supported by the support portion 30, a rotating holder 22, which is installed such as to rotate about the head main body 21, a first dove prism P1, which is installed in the head main body 21, a second dove prism P2, which is installed on the rotating holder 22 such as to have the same optical axis as the optical axis of the first dove prism P1, a lens 23, which is installed on the bottom of the rotating holder 22 and guides light projected by the main body portion 10 to the second dove prism P2, and a reflection mirror 24, which is installed on the head main body 21 and reflects light transmitted by the first dove prism P1 toward the screen S.

### BRIEF DESCRIPTION OF THE DRAWINGS

The above and other features and advantages of the present invention will become more apparent by describing in detail exemplary embodiments thereof with reference to the attached drawings in which:

FIG. 1 is a view for comparing the direction of an image on a material with the direction of an image projected onto a screen by a conventional overhead projector;

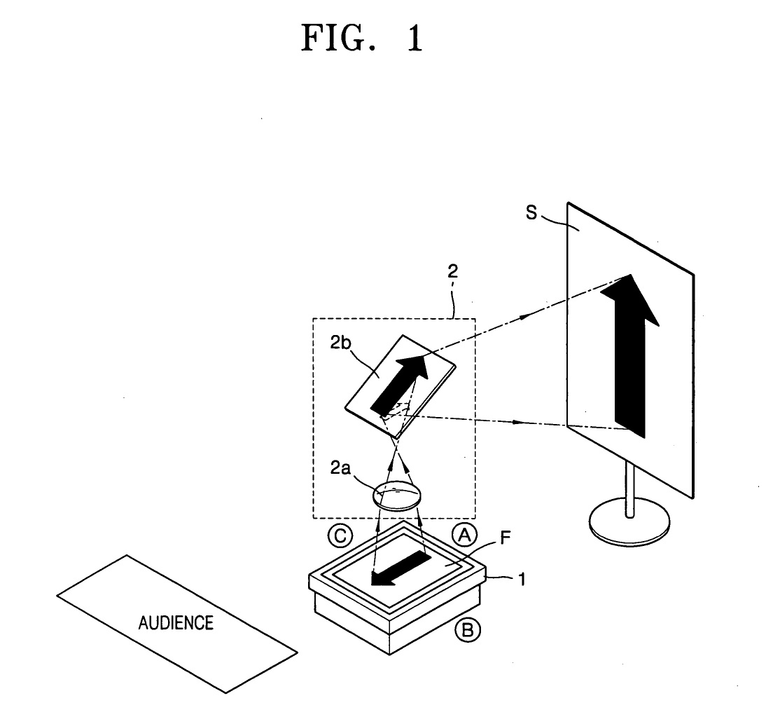

FIG. 2 is a schematic view of an overhead projector according to the present invention;

FIG. 3 explains a dove prism adopted in the overhead projector of FIG. 2;

FIG. 4 illustrates a process in which the phase of an image is changed by the dove prism adopted in the overhead projector of FIG. 2; and

FIG. 5 is a view for comparing the direction of an image on a material with the direction of an image projected onto a screen by the overhead projector according to the present invention.

### DETAILED DESCRIPTION OF THE INVENTION

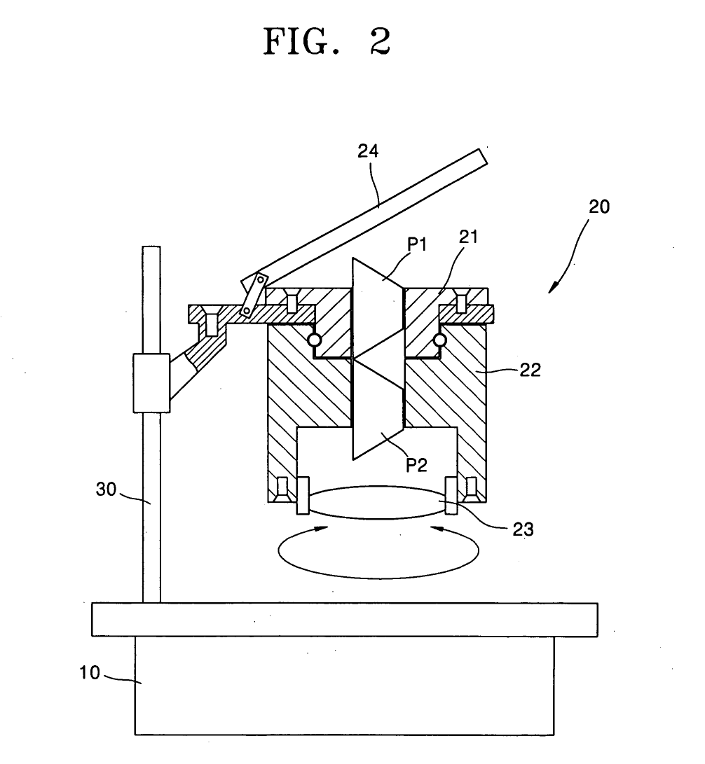

Referring to FIG. 2, an overhead projector according to the present invention includes a main body portion 10, a head portion 20, and a support portion 30. The main body portion 10 includes a light source. The head portion 20 projects an image on a material F, which is a transparent film put on the main body portion 10, onto a screen (not shown). The support portion 30 supports the head portion 20 such that the head portion 20 ascends or descends over the main body potion 10.

A light source such as a halogen lamp or a metal halide lamp is built in the main body potion 10. A manuscript stand, on which the material F is put, is installed over the light source. Since the structure of the main body portion 10 is a common knowledge, this will not be described in greater detail.

The support portion 30 lifts up or down the head portion 20 over the main body portion 10 so that an image is focused on the screen S. Since the structure of the support portion 30 is also a common knowledge, this will not be described in greater detail.

The head portion 20 includes a head main body 21, which is supported by the support portion 30, a rotating holder 22, which is installed such as to be rotated about the head main body 21, a first dove prism P1, which is installed in the head main body 21, a second dove prism P2, which is installed in the rotating holder 22 so as to have the same optical axis as that of the first dove prism P1, a lens 23, which is installed on the bottom of the rotating holder 22 and guides light projected by the main body portion 10 to the second dove prism P2, and a reflection mirror 24, which is installed on the head main body 21 and reflects light transmitted by the first dove prism P1 toward a screen S.

The head main body 21 is supported by the support portion 30 so as to be lifted up or down. The first dove prism P1 is fixed to the head main body 21.

The rotating holder 22 is coupled to the head main body 21 such as to be rotatable. The second dove prism P2 is installed around the center of the rotating holder 22 such as to have the same optical axis as that of the first dove prism P1. The lens 23 is installed on the bottom of the rotating holder 22.

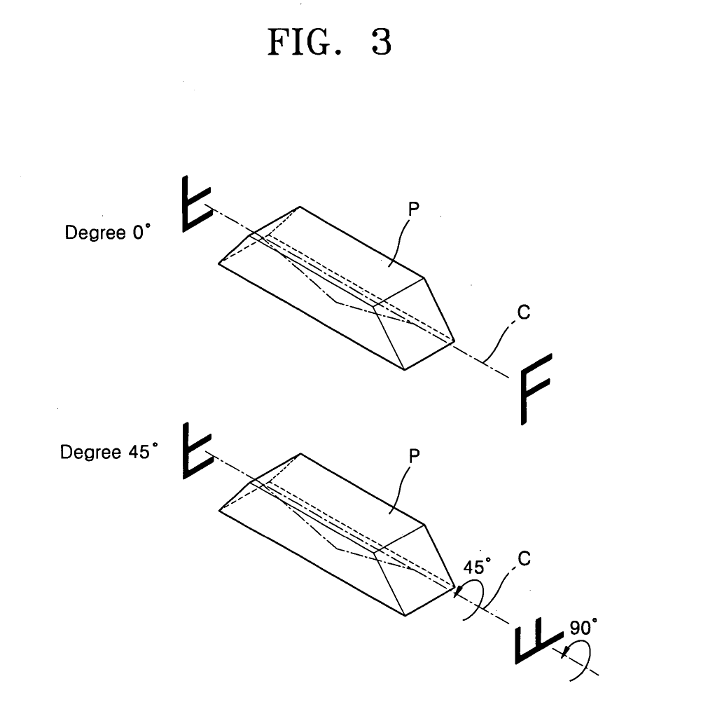

A dove prism P will now be described with reference to FIG. 3. As shown in FIG. 3, the dove prism P is a special prism which shifts an image in all directions. When the dove prism P is rotated about an optical axis C, which is parallel to the lateral sides of the dove prism P, an image is rotated at twice the angle at which the dove prism P rotates. For example, an image is shifted in all directions when the dove prism P has not rotated. The image is rotated at 90 degrees when the dove prism P has been rotated 45 degrees.

The first and second dove prisms P1 and P2 are the dove prisms P with the above-described property.

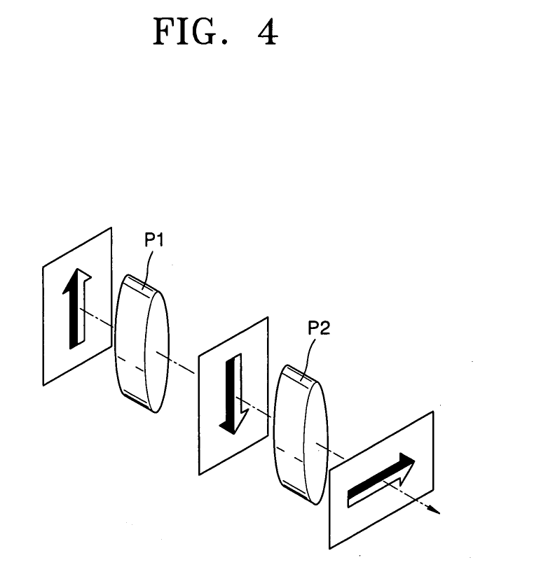

The degree with which an image is shifted with a relative rotation of the first and second dove prisms P1 and P2 will now be described with reference to FIG. 4. Referring to FIG. 4, when the first dove prism P1 has not been rotated, an upward arrow is shifted 180 degrees. The 180° shifted image is shifted 90 degrees by a 45 degree rotation of the second dove prism P2. The phase of an image is changed by the angle of a relative rotation of the first and second dove prisms P1 and P2.

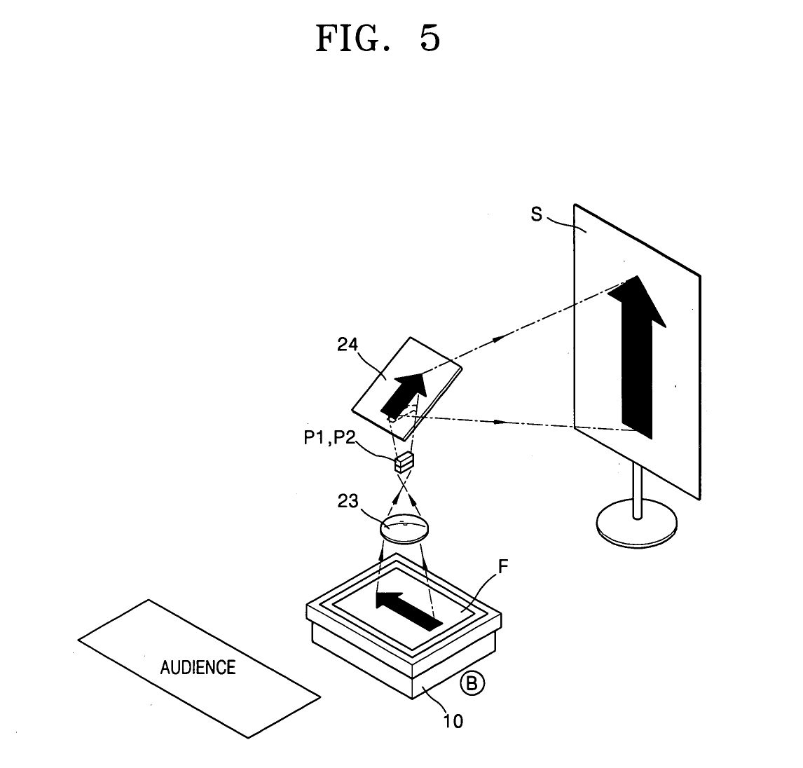

The operation of the overhead projector of FIG. 2 with such a structure will now be described with reference to FIG. 5. As shown in FIG. 5, when a presenter presents the material F, such as a report, to the audience, he or she stands at location \mathring{B} that makes the presenter look sideways at the screen S and the audience. If an arrow printed on the material F is in a forward direction from the location \mathring{B} of the presenter, the arrow is shifted 45 degrees by the first and second dove prisms P1 and P2 so that an upward arrow appears on the screen S. In other words, even when the presenter comfortably writes some contents on the material F or crosses out some contents therefrom at the location where the presenter looks sideways at the audience and the screen S, the added or crossed-out contents are correctly projected onto the screen S. Thus, the presenter can accomplish a correct presentation at a comfortable position.

The first and second dove prisms P1 and P2 can make a relative rotation. Hence, no matter which direction the material F faces, an image of the material F can be properly projected onto the screen S by rotating the second dove prism P2 relatively to the first dove prism P1. Thus, an overhead projector that does not restrict the position of a presenter can be obtained.

As described above, when the overhead projection according to the present invention is used, a presenter can accomplish a presentation at a comfortable location. Further, because an image of the material can be shifted, the presenter can smoothly write something on or cross something out of the presentation material without discomfort.

1. An overhead projector comprising:
a main body portion 10 including a light source;
a head portion 20 which projects an image of a material put on the main body portion 10 onto a screen S; and
a support portion 30 which supports the head portion 20 so that the head portion 20 ascends or descends over the main body portion 10,
wherein the head portion 20 comprises a head main body 21, which is supported by the support portion 30, a rotating holder 22, which is installed such as to rotate about the head main body 21, a first dove prism P1, which is installed in the head main body 21, a second dove prism P2, which is installed un the rotating holder 22 such as to have the same optical axis as the optical axis of the first dove prism P1, a lens 23, which is installed on the bottom of the rotating holder 22 and guides light projected by the main body portion 10 to the second dove prism P2, and a reflection mirror 24, which is installed on the head main body 21 and reflects light transmitted by the first dove prism P1 toward the screen S.
